(19) United States
(12) Patent Application Publication
(10) Pub. No.: US 2011/0266311 A1
(43) Pub. Date: Nov. 3, 2011

(54) CONTAINER WITH MEANS FOR METERING A DOSE OF A PREDETERMINED SIZE

(76) Inventor: Keld Krogh Nielsen, Graasten (DK)

(21) Appl. No.: 13/123,773

(22) PCT Filed: Oct. 16, 2009
(86) PCT No.: PCT/DK2009/000220

§ 371 Date: Apr. 12, 2011

(30) Foreign Application Priority Data
Oct. 21, 2008 (DK) PA 2008 01463
Jul. 3, 2009 (DK) PA 2009 00827

(51) Int. Cl. G01F 11/26

(52) U.S. Cl. 222/454

(57) ABSTRACT

The present invention relates to a container for dosing a free-flowing solid material like granulated solid by pouring. In particular the present invention relates to a container which when a user performs a pouring movement doses a measured dose of a predetermined size. The container (100) comprising: an inner chamber defined by a bottom (106), a sidewall (104) and a top (108); a storage chamber (124); and at least a first dosing channel (112), which is suitable for dosing a metered dose of a predetermined size, the channel (112) is defined by the sidewall (104), a first dividing wall (114) and a second dividing wall (116), the channel (112) comprising an inlet (120) communicating with the storage chamber (124) and an outlet (122), and wherein the dosing channel (112) is configured to dose the metered dose during a pouring movement of the container (100);

### CROSS REFERENCE TO RELATED APPLICATIONS

This application is entitled to the benefit of and incorporates by reference essential subject matter disclosed in International Patent Application No. PCT/DK2009/000220 filed on Oct. 16, 2009 and Danish Patent Application Nos. PA 2008 01 463 filed on Oct. 21, 2008 and PA 2009 00827 filed Jul. 3, 2009.

### FIELD OF THE INVENTION

The present invention relates to a container for dosing a free-flowing solid material like granulated solid by pouring. In particular the present invention relates to a container which when a user performs a pouring movement doses a measured dose of a predetermined size.

### BACKGROUND OF THE INVENTION

Easy and reliable metering of doses of free-flowing solid material is a key issue in many industrial and house hold situations. This is especially the case when deviations from a preferred or optimal dose will have unwanted effects such as serious or even lethal consequences. However, correct metering is also relevant in a lot of other situations e.g. in relation to minimizing costs and preventing pollution.

Accordingly, devices for automatic metering have been developed in which containers for storage of the substance have metering means incorporated therein.

One such example may be seen in U.S. Pat. No. 2,801,034 which discloses a metered dosing container with a metering chamber and a plurality of dosing channels, which may be opened simultaneously or individually in order to dispense a larger or smaller dose. One disadvantage of the invention according to U.S. Pat. No. 2,801,034 is that the user manually may have to cover one of the outlets by hand in order to achieve the desired dose. Another disadvantage of the invention according to U.S. Pat. No. 2,801,034 is that for each dosing by means of one of the dosing channels, even more of the free-flowing solid material is filled into the other dosing channel, whereby the dose is incorrectly metered when said other dosing channel is used the next time.

It is an object of an embodiment of the present invention to provide a dispensing container allowing the user to choose and dispense a dose using only one hand.

Moreover, it is an object of an embodiment of the present invention to provide a dispensing container providing a correct dose each time the container is used, regardless of which of its dosing channels have been used most recently.

It is furthermore an object of an embodiment of the present invention to provide a dispensing container where the user can change the predetermined size of the measured dose.

### SUMMARY OF THE INVENTION

The present invention relates to a container for dosing a free-flowing solid material like granulated solid by pouring, the container comprising:
an inner chamber defined by a bottom, a sidewall and a top;
a storage chamber; and
at least a first and a second dosing channel each of which is suitable for dosing a metered dose of a predetermined size, each channel comprising an inlet communicating with the storage chamber and an outlet, and wherein each dosing channel is configured to dose the metered dose during a pouring movement of the container in an optimal pouring direction which is optimal for pouring the metered dose with the respective dosing channel;
   wherein the dosing channels are arranged such with respect to each other that dosing with a first of the dosing channels in the optimal dosing direction will cause at least a part of the metered dose contained in each of the remaining dosing channels to flow into the storage chamber.

One advantage of the present invention is that pouring by means of one of the dosing channels will not cause the metered content contained in any of the remaining dosing channels to be dispensed, as the content instead of being emptied out through the respective outlets, returns to the storage chamber as it flows into the storage chamber through the inlet. Another advantage is that the metered dose in the dosing channel is not gradually increased when another dosing channel is used, as the content of any of the remaining dosing channels (upon completing the pouring movement) has a volume lower than the volume of a metered dose, for the respective channel, whereby repositioning the container to its upright position after pouring will simply cause a correct dose to be metered.

In one embodiment, the dosing channels are positioned relative to each other such that during use, the inlet of an active pouring channel, by means of which the metered dose is being poured, may be positioned at a point below the remaining inlets during at least a part of the pouring movement.

Free-flowing solid material is the term used for the material to be dosed. The material may be in the form of powders, granulates, pills or the like, for example washing powder, dried food for animals, fertilizers, different types of food material like breakfast cereals, grits, oats, etc.

In the context of the present invention terms like horizontal, vertical, upper, lower, top, bottom etc. shall—unless otherwise stated—be used to describe the container in a situation in which the container is positioned in an upright position on a horizontal surface i.e. in a situation in which a bottom surface of the container is contacting said horizontal surface. However, the skilled person will readily realize that the container may be positioned in any other way and will indeed be so during pouring of the free-flowing solid material.

The inner chamber defines an inner surface defined by respective inner surfaces of the bottom, the sidewall and the top. In one embodiment, the container may be defined by a base part defining the bottom and the sidewall, and a lid defining the top. The base part defining the sidewall and the bottom may define a monolithic element (i.e. one element without seams separating the bottom and the sidewall). In one embodiment, the lid is permanently fastened to the base part e.g. by welding or gluing or interference fit. In another embodiment, the lid is detachably fastened to the base part, which allows for removal of the lid such that the container may be refilled. In an alternative embodiment, the lid comprises a refill inlet which may be closed during normal use of the container so as to prevent the free-flowing solid material from being poured out of refill inlet, while pouring through one of the pouring channels/outlets.

In one embodiment, the inner chamber defines a storage chamber and two or more dosing channels. A general/longitudinal direction of at least one of the dosing channels may extend vertically inside the container. In one embodiment, the longitudinal direction of all the dosing channels extends in the vertical direction of the container. In one embodiment, one or more, such as all, of the dosing channels extend along the inner sidewall of the container, such that the inner sidewall of the container defines an inner surface of the dosing channel.

The container comprises two or more dosing channels, such as three, such as four, such as five. Each of the dosing channels is adapted to dose a metered dose of a predetermined size. In one embodiment, the sizes of at least two of the metered doses are different. In one embodiment, none of the metered doses are identical in size.

The inlet of one or more of the dosing channels may be provided in the lower half of the container, such as in the lower third, such as in the lower quarter. Additionally, the outlets of the dosing channels may be provided in the upper half of the container, such as in the upper third, such as in the upper quarter. The outlets may be defined in the top and may comprise means for closing the outlet e.g. such that moisture may be prevented from entering the container when the container is not used. In one embodiment, each means for closing one of the outlets is pivotally connected to the top such that the outlet automatically opens during pouring.

As previously mentioned, each of the dosing channels are adapted to dose a metered dose during a pouring movement of the container in an—for the respective dosing channel—optimal pouring direction. It will be appreciated that the optimal dosing direction is different for each of the dosing channels so as to allow a user to pour a metered dose by means of one dosing channel without simultaneously dosing with one of the other dosing channels.

In one embodiment, the pouring direction of at least one (such as each) of the dosing channels extends from a geometrical centre of a horizontal cross section of the container through the representation of the respective dosing channel in said horizontal cross-section. In the latter embodiment, a metered dose may be poured by means of the respective channel, by rotating the container about a normal of a vertical plane extending through the dosing direction.

In one embodiment, the inlets are positioned relative to each other such that two lines extending from the centre of gravity and/or the geometrical centre of the container to the geometrical centre of two different inlets define an angle which is above 60 degrees.

In one embodiment, the angle is in the range 160-180 degrees whereby the two inlets are positioned substantially opposite each other.

In one embodiment, the cross section of the container in the horizontal plane defines a triangle in which the dosing channels are defined in the corners of the triangle. The length of the three sides of said triangle is in one embodiment substantially identical, while they in others embodiments have different lengths.

The cross-sectional shape of the container may define any other polygonal shape such as a quadrangle, and the dosing channels may be defined in the corners of such polygonal cross sections. In another embodiment, the cross-section may be round. The container may comprise a metal material or a plastic material and may be reinforced by fiber glass, Kevlar or the like.

The outlets may be defined in the top of the container. Alternatively, the outlets may be defined in the upper part of the sidewall.

In order to allow the container to dispense doses of different size, the cross-sectional area of at least two of the inlets may be different in size, and/or the vertical position of at least two of the inlets may be different. In one embodiment, the cross-sectional area of each of the inlets is different than the cross-sectional area of any of the remaining inlets, and/or the vertical position of each of the inlets is different than the vertical position of any of the remaining inlets.

In one embodiment, each of the channels defines a metering zone which is filled up with the free-flowing solid material when the container is in its upright position. In one embodiment, the upper boundary of the metering zone is defined by the uppermost part of the inlet. When a dose is dispensed the metering zone is emptied as the free-flowing solid material located in the zone flows out of the dispensing channel and exits the container thought the outlet associated with the respective dosing channel. When the container again is positioned in its upright position, the free-flowing solid material flows into the metering zone such that a new dose may be dispensed. It will be appreciated, that in some embodiments the free-flowing solid material flows into the metering zone during the movement of the container from a substantially horizontal position to a substantially vertical/upright position. Moreover, it will be appreciated that the volume of the metering zone is decisive for the size of the dose dispensed. In most embodiments, the volume of the metering zone is substantially equal to the volume of the dose which is dispensed by means of the dosing channel associated with the respective metering zone.

In one embodiment, the inlets are positioned symmetrically relative to a vertical plane extending through the centre of the top and the bottom, i.e. opposite each other relative to the plane.

In one embodiment, each of the inlets is defined by a first and a second dividing wall which are spaced apart inside the inner chamber and are arranged with respect to each other such that the lower surface (e.g. defined by the lower edge) of the first dividing wall and the upper surface (e.g. defined by the upper edge) of the second dividing wall are provided at substantially the same horizontal plane. In one embodiment, the second dividing wall is provided closer to the centre of the container than the first dividing wall, whereby the inlet defined by the two walls extends radially outwards from the upper surface of the second (inner) dividing wall to the lower surface of the first (outer/lateral) dividing wall.

In one embodiment the container for dosing a free-flowing solid material by pouring comprises:
an inner chamber defined by a bottom, a sidewall and a top ,
a storage chamber, and
at least a first dosing channel, which is suitable for dosing a metered dose of a predetermined size, the channel is defined by the sidewall, a first dividing wall and a second dividing wall, the channel comprising an inlet communicating with the storage chamber and an outlet, and wherein the dosing channel is configured to dose the metered dose during a pouring movement of the container;
   wherein the first dividing wall or a part of it or the second dividing wall is movable inside the inner chamber so as to allow a user to change the predetermined size of the measured dose.

As the volume of the metering zone is determined by the first and/or second dividing walls, at least one of the dividing walls may in one embodiment be adapted to allow a user to change its configuration inside the inner chamber. In one embodiment, the second dividing wall is adapted to be moved inside the container. As an example, the container may define a plurality of grooves for receiving the second dividing wall. Accordingly, the user may change the position of the dividing wall and thus increase or decrease the metering volume.

Accordingly, at least one of the dividing walls may be movable horizontally and/or vertically inside the inner chamber so as to allow a user to change the predetermined size of the measured dose which may be dosed by means of the channel which is at least partly defined by the respective first and second dividing walls.

In one embodiment, the first dividing wall comprises a sliding wall. Accordingly, the user may extend the first wall and thus reduce the metering volume. The sliding wall may have the full height of the container and the user may then pull the sliding wall upwards to correspond to the desired dose. In one embodiment, the sliding wall may have a lower height than the height of the container, and thereby it will be possible for the user to choose a dose and pull the sliding wall upward without pulling the sliding wall over the upper edge of the container.

In one embodiment, the first dividing wall or part of it, such as a sliding wall, is movable up and down by sliding the wall in two oppositely placed grooves. Grooves provide one possible solution, but other features for supporting the wall may be chosen.

In one embodiment, the sliding wall is sliding against the first dividing wall. The first dividing wall and the sliding wall may comprise securing means preferably having form as a groove and a protrusion.

In one embodiment, the sliding wall is provided with projections or grooves which engage corresponding projections or grooves in the first dividing wall. These projections or grooves may be made to correspond to specific doses. When the sliding wall is moved, it will stop at this specific dose and the user will need extra force to move the sliding wall further. This arrangement secures that, when a user performs a pouring movement, he gets measured dose of a predetermined size.

In one embodiment, the sliding wall comprising grips for helping the user to change the position of the sliding wall in the container.

In one embodiment, the sliding wall may be marked with different portion sizes, hereby it will be easy for the user to select a desired dose.

### BRIEF DESCRIPTION OF THE DRAWINGS

Examples of the invention will now be described in further detail with reference to the drawings in which:

FIG. 1 discloses the section A-A of the container,

FIG. 2 discloses a side elevational view of the container and the section line A-A,

FIG. 3 discloses the section A-A of the lid,

FIG. 4 discloses a top elevational view of the lid and the section line A-A,

FIGS. 5 and 6 each discloses a side elevational view of the lid,

FIGS. 7 and 8 disclose an isometric view of the lid and the lower part, respectively,

FIG. 9 discloses the section A-A of the lower part,

FIGS. 10 and 11 disclose side and top elevational views of the lower part, respectively.

FIG. 12 discloses another embodiment B,

FIG. 13 discloses an isometric view of the lower part of the embodiment B without the sliding wall,

FIG. 14 discloses the lid of the embodiment B

FIG. 15 discloses the sliding wall

FIG. 16 discloses a section of an isometric vief of the embodiment B with the sliding wall.

### DETAILED DESCRIPTION OF THE PREFERRED EMBODIMENTS

The container 100 comprises a lower part 102 defining a sidewall 104 and a bottom 106, and a top 108 defining two closures 110,110′. Each of the closures 110,110′ is arranged to cover/close a dosing channel 112,112′ defined in the lower part 102 and the top 108. Each dosing channel 112,112′ is defined by a part of the sidewall 104, a first dividing wall 114,114′ and a second dividing wall 116,116′.

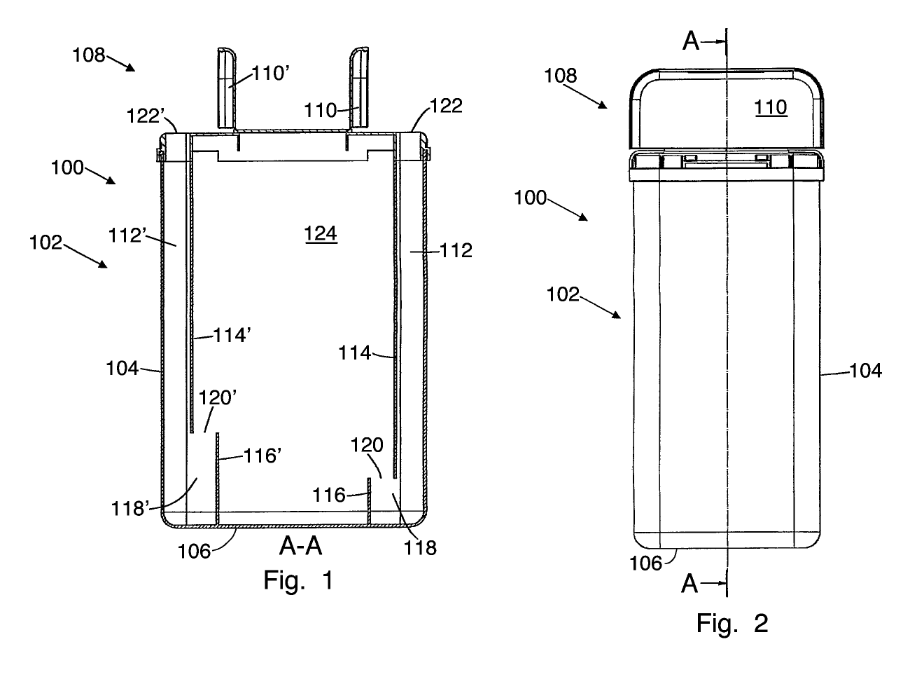

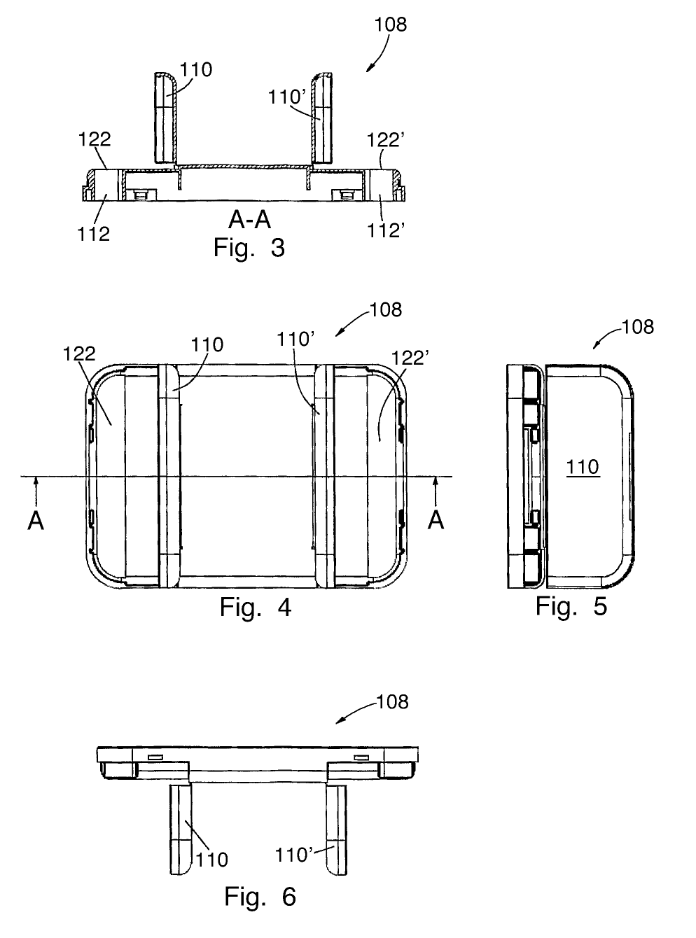

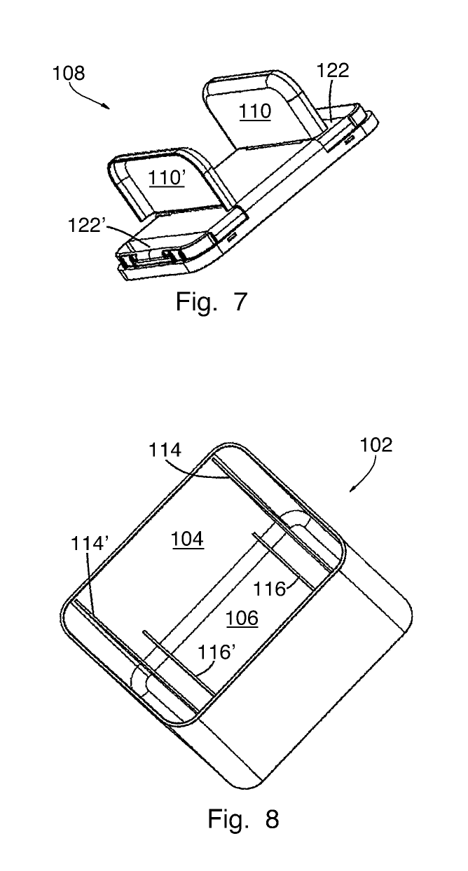

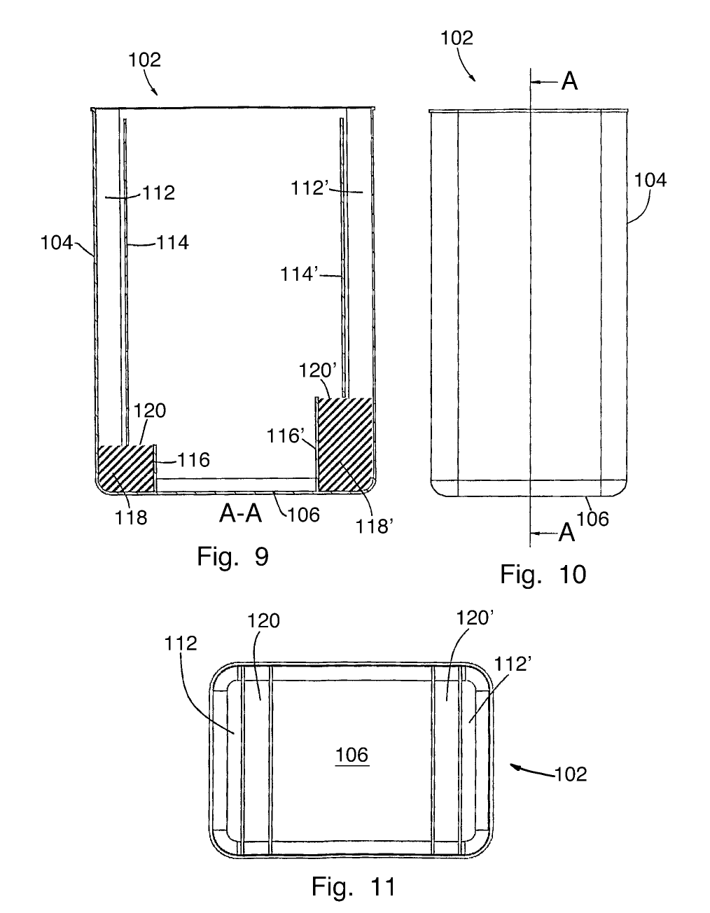

Moreover, each of the dosing channels 112,112′ defines a metering zone 118,118′. The metering zones 118,118′ are illustrated by the hatched areas in FIG. 9. Each metering zone 118,118′ is defined by a part of the sidewall 104 and the second dividing wall 116,116′, whereby it will be appreciated that the height and the lateral position of the second dividing wall 116,116′ determines the size/volume of the dose. In FIGS. 1 and 9 the lateral position of the second dividing walls 116,116′ are identical. However due to the difference in height of the two second dividing walls 116,116′ the volume of the respective metering zones are different. Accordingly, the large metering zone 118′ is more voluminous than the small metering zone 118.

In the embodiment of the figures, the upper surface of the second dividing wall 116,116′ and the lower surface of the first dividing wall 114,114′ of each dosing channel 112,112′ are provided in substantially the same horizontal plane and together define an inlet 120,120′ of the dosing channel 112,112′. After each dosing with one of the dosing channels 112,112′, the free-flowing solid material flows into the respective metering zone 118,118′ through the respective inlet 120,120′. In the opposite end of each dosing channel 112,112′, an outlet 122,122′ is provided through which the dose of free-flowing solid material exits the container 100 during dispensing.

In the following, use of the container is described with reference to FIG. 1. Prior to use the free-flowing solid material (not shown) is provided in a storage chamber 124 and due to the arrangement of the inlet 120 at least a part of the free-flowing solid material (not shown) will flow into the metering zones 118,118′ such that both metering zones 118,118′ are filled with the free-flowing solid material. When the user desires to dispense a large dose, the container 100 is tilted to the left in the drawing. This causes the inlet 120 of the small metering zone 118 to be elevated to a position above the inlet 120′ of the large metering zone 118′. Moreover, the tilting movement gradually causes the small metering zone 118 to be positioned above the storage chamber 124, whereby the content of the small metering zone 118 is emptied into the storage chamber 124, and prevented from being dispensed though the dosing channel 112. Moreover, the free-flowing solid material located in the large metering zone 118 is caused to flow inside the dosing channel 112′ and out through the outlet 122′.

It will be appreciated that a small dose is achieved by tilting the container 100 to the right in the figure, whereby the free-flowing solid material located in the small metering zone 118 will flow inside the dosing channel 112 and out through the outlet 122 associated therewith. Moreover, it will be appreciated that the content of the large metering zone 118′ will be emptied into the storage chamber 124 during dispensing of the small dose.

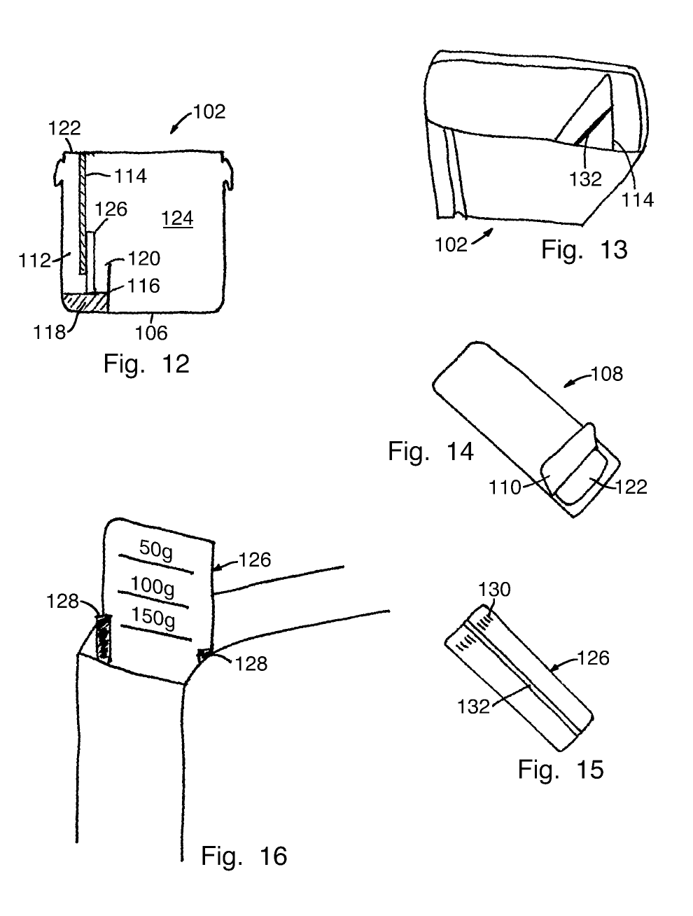

FIG. 12 is a schematic illustration of a lower part 102, where the first dividing wall 114 comprises a sliding wall 126. The sliding wall 126 is inserted into the container and slid down to fit the dosage required. The sliding wall 126 is preferably located on the side of the first dividing wall 114 facing towards the storage chamber 124. This location will provide the user with space for changing the position of the sliding wall 124.

FIG. 13 is a perspective view of the lower part 102 without the sliding wall. FIG. 15 is a schematic illustration of a sliding wall 126 for the lower part 102 of FIG. 13. Securing means 132 having form as a protrusion on the first dividing wall 114 and as a groove in the sliding wall 126 ensure that the sliding wall stays in the desired position in relation to the first dividing wall and thereby ensure the same measured dose each time the container is pouring. Grips 130 placed in the sliding wall 126 helping the user to change the position of the sliding wall 126 in the container.

FIG. 16 is a perspective view of the lower part of the container 102 provided with two oppositely placed grooves 128. The dividing wall 114 or part of it 126 may be movable up and down by sliding the sliding wall 126 in the grooves. The wall may be marked with different portion sizes, which help the user place the wall in the correct position and thereby ensure the same measured dose each time the container is tilted. The first dividing wall is disclosed as an integrated part of the container, but the dividing wall may as well be slid in the container.

The dividing wall comprising the sliding wall may have a form as disclosed in FIG. 12 where the sliding wall overlaps the dividing wall and where the sliding wall may be slid down to the desired portion size. In such an embodiment, it will be possible that the height of the dividing wall does not extend above the container and thereby it will be possible to store the container with the lid on and still have the first dividing wall with the sliding wall in the desired position to ensure the same measured dose each time the container is pouring.

While the present invention has been illustrated and described with respect to a particular embodiment thereof, it should be appreciated by those of ordinary skill in the art that various modifications to this invention may be made without departing from the spirit and scope of the present.

What is claimed is:

1. A container for dosing a free-flowing solid material by pouring, the container comprising:
an inner chamber defined by a bottom, a sidewall and a top;
a storage chamber; and
at least a first and a second dosing channel, each of which is suitable for dosing a metered dose of a predetermined size, each channel comprising an inlet communicating with the storage chamber and an outlet, and wherein each dosing channel is configured to dose the metered dose during a pouring movement of the container in an optimal pouring direction which is optimal for pouring the metered dose with the respective dosing channel;
wherein the dosing channels are arranged such with respect to each other that dosing with a first of the dosing channels in the optimal dosing direction will cause at least a part of the metered dose contained in each of the remaining dosing channels to flow into the storage chamber.

2. The container according to claim 1, wherein the dosing channels are positioned relative to each other such that during use, the inlet of an active pouring channel, by means of which the metered dose is being poured, may be positioned at a point below the remaining inlets during at least a part of the pouring movement.

3. The container according to claim 1, wherein the inlets are positioned relative to each other such that the horizontal projection of two lines extending from the center of gravity of the container to the geometrical center of two different inlets define an angle which is above 60 degrees.

4. The container according to claim 1, comprising two dosing channels positioned opposite each other in the container.

5. The container according to claim 1, wherein the outlets are defined in the top surface of the container.

6. The container according to claim 1, wherein the cross-sectional areas of the inlets are different in size and/or the vertical positions of the inlets are different.

7. The container according to claim 1, wherein the inlets are positioned symmetrically relative to a plane extending through the centre of the top and the bottom.

8. The container according to claim 1, wherein each of the inlets is defined by a first and a second dividing wall which are spaced apart inside the inner chamber and are arranged with respect to each other such that the lower surface of the first dividing wall and the upper surface of the second dividing wall are provided at substantially the same horizontal plane.

9. The container according to claim 8, wherein at least one of the dividing walls is adapted to allow a user to change its configuration inside the inner chamber.

10. The container according to claim 8, wherein at least one of the dividing walls is movable horizontally and/or vertically inside the inner chamber so as to allow a user to change the predetermined size of the measured dose which may be dosed by means of the channel which is at least partly defined by the respective first and second dividing walls.

11. A container for dosing a free-flowing solid material by pouring, the container comprising:
an inner chamber defined by a bottom, a sidewall and a top;
a storage chamber; and
at least a first dosing channel, which is suitable for dosing a metered dose of a predetermined size, the channel is defined by the sidewall, a first dividing wall and a second dividing wall, the channel comprising an inlet communicating with the storage chamber and an outlet, and wherein the dosing channel is configured to dose the metered dose during a pouring movement of the container;
wherein the first dividing wall or a part of it or the second dividing wall is movable inside the inner chamber so as to allow a user to change the predetermined size of the measured dose.

12. The container according to claim 11, wherein the first dividing wall comprises a sliding wall.

13. The container according to claim 11, wherein the first dividing wall or part of it is movable up and down by sliding in two oppositely placed grooves.

14. The container according to claim 12, wherein the sliding wall is sliding against the first dividing wall.

15. The container according to claim 14, wherein the first dividing wall and the sliding wall comprising securing means preferably having form as a groove and a protrusion.

16. The container according to claim 12, wherein the sliding wall comprising grips for helping the user to change the position of the sliding wall in the container.
